(19) United States
(12) Patent Application Publication
(10) Pub. No.: US 2020/0405453 A1
(43) Pub. Date: Dec. 31, 2020

(54) Method and Apparatus for Installation of Prefabricated Prostheses onto Dental Implants

(71) Applicant: Louie Al-Faraje, San Diego, CA (US)

(72) Inventor: Louie Al-Faraje, San Diego, CA (US)

(21) Appl. No.: 16/910,572

(22) Filed: Jun. 24, 2020

Related U.S. Application Data
(60) Provisional application No. 62/866,172, filed on Jun. 25, 2019.

(51) Int. Cl. A61C 8/00; A61C 13/01; A61C 13/10

(52) U.S. Cl. CPC A61C 8/009; A61C 13/1013; A61C 13/01; A61C 8/001

(57) ABSTRACT

A plate (30 or 40) used for installing a prefabricated prosthesis (62) on to free-hand installed implants (52) includes a plastic structure (30 or 40) shaped and configured to mate with an arch (10), a plurality of perforations in the plastic structure, and a plurality of removable panels (32 or 42) corresponding to the plurality of perforations. The plurality of removable panels are designed and configured for removal in locations corresponding to locations of the free-hand installed implants and further configured to deliver the prosthesis on to the implants using the plastic plate.

### CROSS-REFERENCE TO RELATED APPLICATIONS

This application claims priority from U.S. Provisional Application No. 62/866,172, filed Jun. 25, 2019, the entire contents of which is incorporated herein by reference.

### FIELD OF THE DISCLOSURE

The present disclosure is generally related to systems and methods for installing dental prosthesis onto dental implants, and more particularly to installing pre-fabricated prosthesis onto dental implants that have been implanted using a free-hand method.

### BACKGROUND

Full arch dental implant surgery can be done using a guided method or a free hand method.

Then after the implants are placed, the temporary restoration (if immediate loading is to be done) can be placed using a prefabricated prosthesis or by converting a denture.

### BRIEF DESCRIPTION OF DRAWINGS

FIG. 1 is a representation of some of the different arch shapes that can be used with the embodiments herein;

FIG. 2 is a representation illustrating the use of Swiss locks for attaching the plastic plate with panels to the arch in accordance with the embodiments;

FIG. 3 is a representation of the plastic plate with a plurality of removable panels in accordance with the embodiments;

FIG. 4 is a representation of the plastic plate in translucent form having one of the panels removed from the plurality of removable panels in accordance with the embodiments;

FIG. 5 is a representation of the plastic plate with abutments sticking through it and FIG. 5A is an arrangement illustrating an exploded view of the prosthesis, plastic plate and jaw with implants and abutments; and

FIG. 6 is a flow chart disclosing the method of installation in accordance with the embodiments.

### DETAILED DESCRIPTION

The method, system, and apparatus in accordance with the embodiments facilitates the delivery (or the installation) of the prefabricated prostheses onto the implants that are placed by the free hand method and that are candidates for immediate loading or use by the patient. In some embodiments, alveoplasty (bone reduction or reshaping) AND implant placement are BOTH done without a guide and done completely by the free hand method. Delivery of the prosthesis is simplified by the use of Prefabricated arches that are installed on the jawbone of a patient AFTER the alveoplasty and the implant placement are done. The delivery is also simplified by the use of the plastic plate that will help in holding the prosthesis in place and minimize the amount of reline material used during delivery or installation of the prosthesis onto the implants.

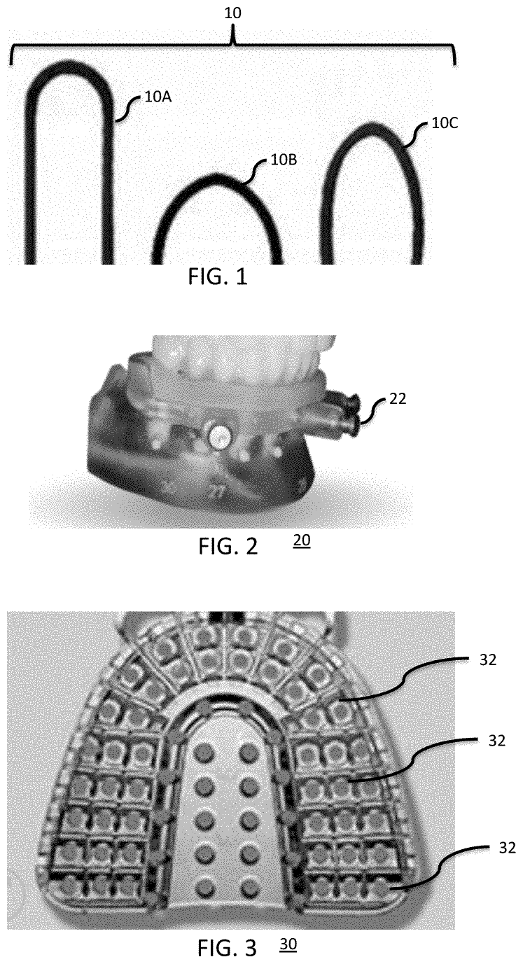

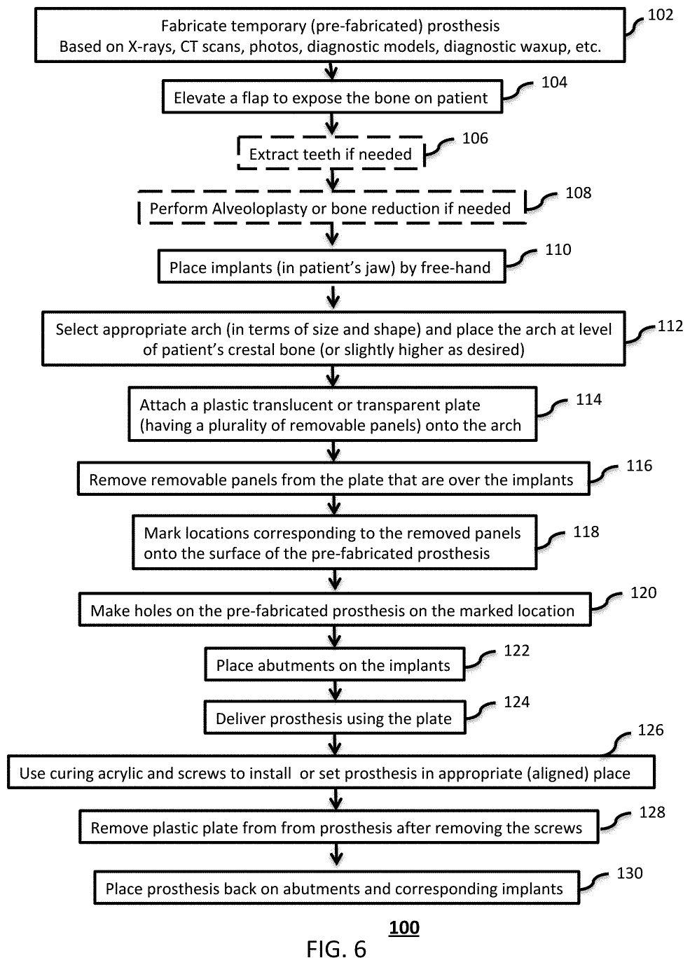

Referring to the various figures (FIGS. 1-6) and particularly to a method 100 as shown in FIG. 6, the method 100 can begin with the fabrication of the temporary prosthesis at step 102. The temporary or pre-fabricated prosthesis can be made on the basis of X-rays, CT scans, photographs, diagnostic models, diagnostic waxups, or other methods. At step 104, a flap (of gum) can be elevated to expose the bone underneath. If needed, teeth are extracted at step 106 and alveoloplasty or bone reduction is performed at step 108 if needed. Alveoloplasty is a dental pre-prosthetic procedure performed to smoothen or reshape the jawbone. In this procedure, the bony edges of the alveolar ridge and its surrounding structures is made smooth, redesigned or recontoured so that a well-fitting, comfortable, and esthetic dental prosthesis may be fabricated. At step 110, implants are placed in the patient's jaw by the free-hand method.

Next, the doctor or practitioner selects at step 112 an appropriate arch for placement at a level of the patient's crestal bone (or slightly higher as desired). The selection of the arch can be based on the appropriate size and shape best suited for a particular patient.

Note that human jaws are either U shape, or square shape or V shape. See FIG. 1 for some of the exemplary shapes 10 that can be used for the arch. Shape 10A is a substantially U shaped arch, shape 10B is a substantially square shaped arch, and shape 10C is a substantially V shaped arch. Other shapes and sizes for the arches are contemplated within the embodiments herein and such shapes and sizes are not necessarily limited to those illustrated.

In one embodiment, fabrication of 3 metal arches of three different shapes (U, square, or V) and of two (2) different sizes of each can be made for selection (as part of a kit enabling a few shapes and sizes fits all). For example, a kit can include 6 titanium arches having a small/medium (S/M) size and Large/extra-large (L/XL) size for each shape-type of arch. Some shapes and sizes are better suited to particular genders. Of course, greater granularity in terms of shapes and sizes can be provided for the arch and the embodiments are not necessarily restricted to any particular number of shapes or sizes as mentioned above.

After the implants are placed at step 110, the doctor will pick one of the (6 or other number of) arches and will install it onto the patient's jaw at the level of the crestal bone (or the level of the alveoloplasty if performed) at step 112.

Using an attachment mechanism 20 such as Swiss locks as shown in FIG. 2, the doctor then will install a plastic plate onto the arch at step 114. Although the method and system is not limited to Swiss locks, the attachment mechanism preferably uses Swiss locks for this purpose. The plastic plate can be translucent or transparent to allow the doctor to easily locate the implants that lay underneath.

A plastic plate 30 can have a perforated surface (a honey comb-look as shown in FIG. 3) and include a plurality of removable panels (or pieces) 32.

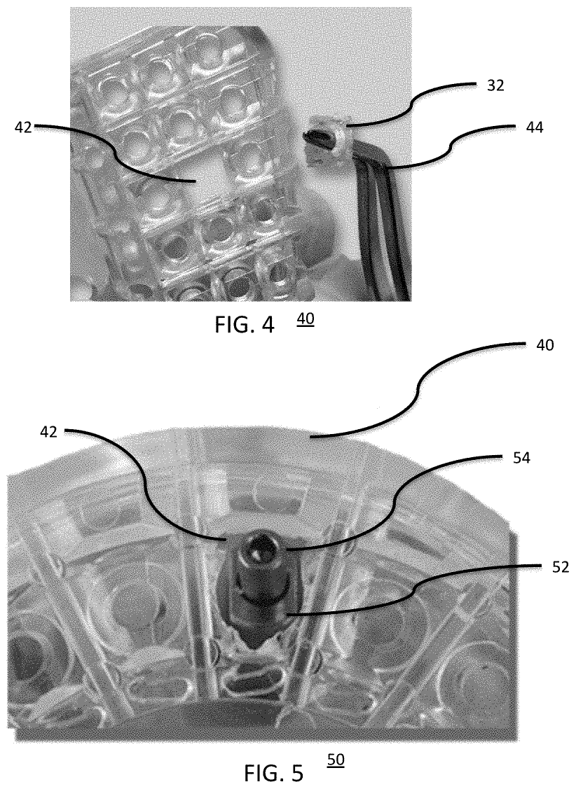

The doctor will remove the panels 32 that are on the top of the implants at step 116. See FIG. 4 showing how a panel 32 on a plate 40 can be removed with a tool 44 leaving a gap 42 in the plate 40 as illustrated.

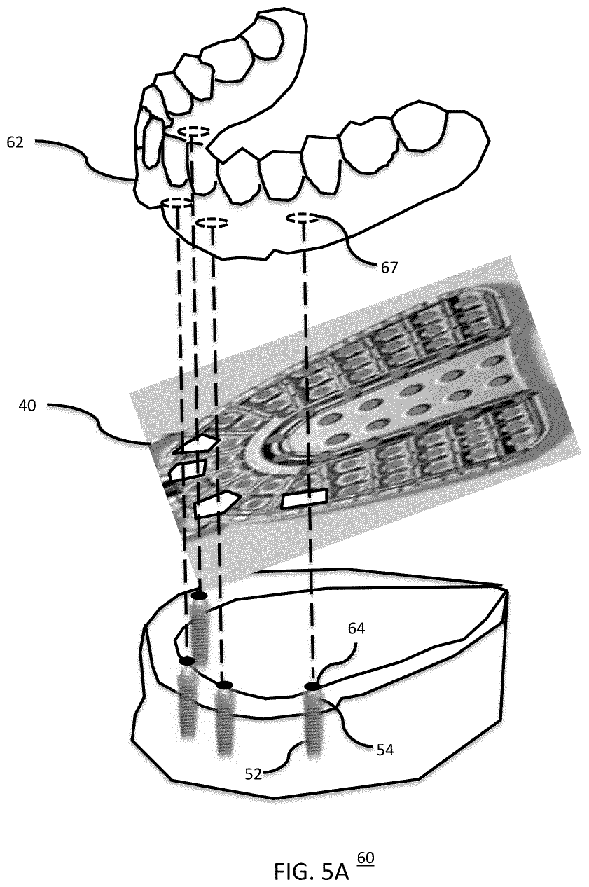

Next the abutments 54 will be installed on the implants 52 as illustrated in FIG. 5.

The doctor will verify that the abutments 54 are sticking through the removed panels 32 (shown as already removed) or their corresponding gap 42 on the plastic trays 40 as shown in the configuration 50 of FIG. 5.

At step 118 and with reference to the arrangement 60 of FIG. 5A, the method further includes marking locations corresponding to the removed panels (42) onto a surface of a prefabricated prosthesis 62. In some embodiments, some form of marking paint or ink 64 can be placed on the abutments 52 and then the prefabricated dentures can be placed on the abutments so that the paint will mark the locations 67 of the abutments on the intaglio surface of the prosthesis.

At step 120, holes are made in the prosthesis 62 in these marked locations 67 and the prosthesis 62 is delivered (picked up) at step 124 using this plate 40 after installment of the abutments at step 122.

At step 126, curing acrylic (hard reline) and screws are used to install the prosthesis in the appropriate or aligned place. Once the pick up material (hard reline) is set at step 126, the prosthesis can be removed so the plastic plate 40 at step 128 can be removed after removing the screws and the prosthesis 62 is placed back on the implants 52 and abutments 54 at step 130. The method 100 of FIG. 6 and accompanying system does not need computer-based treatment planning, the guides are not placed for implant placement, and the metal arches are prefabricated.

Further note that the sizes, shapes, number of panels, or materials used for the arch, or plate or panels are shown as exemplary embodiments and not necessarily limited to the embodiments disclosed herein. Ideally, the number of shapes and sizes for the arch will be limited to approach a few sizes fits all instead of having to manufacture many different shapes and sizes for kits. The material used for the arch is preferably a metal suitable for sterilization such as titanium. The plates can have any number of removable panels, but again the number of panels on a plate is hopefully configured and designed so that a few or a single plate configuration will be suitable for most patients. The material used for the plate is preferably translucent or transparent material such as a translucent or transparent plastic that can be sterilized using cold sterilization or UV light for example. Furthermore, plastic is ideally suited for creating the removable panels in the structure of the plate. The reline material is preferably a fast curing acrylic enabling the appropriate placement and setting of the prosthesis using hard reline material, for example, so that the system does not need to stay in place within the patient's mouth and enabling the patient to have the finished (implant) aligned prosthesis within a relatively short period of time.

Again, use of the plastic plate with the perforations not only helps with alignment with the abutments where implant placements and alveoplasty are done via the free-hand method, but also serves as a delivery mechanism for placement of the prosthesis during the curing process of the reline or acrylic. The plastic plate helps with the placement of the acrylic placed around the holes in the prosthesis that enable a better and more accurate fit with the implants and abutments (that were placed via free-hand) and also provide a easy mechanism and guide to place the prosthesis on the abutments since the orthodontist or their assistants or other practitioner may be going in a bit blind since the holes 67 (see FIG. 5A) in the prosthesis 62 might be hidden behind the “teeth” as the prosthesis is being delivered onto the abutments. The plastic plate with the removed panels serves as a guide notwithstanding the holes 67 of the prosthesis possibly being hidden from view to the practitioner during delivery of the prosthesis onto the abutments (for the curing process) or otherwise.

What is claimed is:

1. A method of installing a prefabricated prosthesis on to free-hand installed implants, comprising the steps of:
selecting an arch suitable for a patient;
attaching a plate having a plurality of perforations and removable panels corresponding to the plurality of perforations to the arch;
removing a set of removable panels corresponding to locations of the free-hand installed implants;
aligning the set of removable panels with a surface of the prefabricated prosthesis;
creating holes in the prefabricated prosthesis in the locations corresponding to the set of removable panels;
delivering the prosthesis on to the implants using the plate;
using reline to set the prosthesis in place adjacent to the implant;
once the reline is set, removing the plate from the reline and prosthesis; and
placing the prosthesis back on the implant.

2. The method of claim 1, wherein the arch is comprised of metal.

3. The method of claim 1, wherein the arch is comprised of titanium.

4. The method of claim 1, wherein the arch is selected from among one of a U-shaped arch, a square shaped arch, or a V-shaped arch.

5. The method of claim 1, wherein the arch is selected from among a sizing of small/medium or large/extra-large.

6. The method of claim 1, wherein the arch is selected from a combination of shape and sizing comprising among one of a U-shaped arch, a square shaped arch, or a V-shaped arch and sizing of small/medium or large/extra-large.

7. The method of claim 1, wherein the plate is attached to the arch using Swiss locks.

8. The method of claim 1, wherein the plate having the plurality of perforations is made from plastic.

9. The method of claim 1, wherein the plate having the plurality of perforations is made from a translucent or transparent plastic.

10. The method of claim 1, wherein the reline is hard reline.

11. A method of installing a prefabricated prosthesis on to free-hand installed implants, comprising the steps of:
selecting an metal arch suitable for jaw bone shape of a patient selected from a combination of shape and sizing comprising among one of a U-shaped arch, a square shaped arch, or a V-shaped arch and sizing of small/medium or large/extra-large;
attaching a plastic plate having a plurality of perforations and removable panels corresponding to the plurality of perforations to the metal arch using Swiss locks;
removing a set of removable panels corresponding to locations of the free-hand installed implants;
aligning the set of removable panels with a surface of the prefabricated prosthesis and correspondingly marking the prefabricated prosthesis;
creating holes in the prefabricated prosthesis in the locations corresponding to the set of removable panels;
delivering the prosthesis on to the implants using the plate;
using reline to set the prosthesis in place adjacent to the implant;
once the reline is set, removing the plate from the reline and prosthesis; and
placing the prosthesis back on the implant.

12. A plate used for installing a prefabricated prosthesis on to free-hand installed implants, comprising:
a plastic structure shaped and configured to mate with an arch
a plurality of perforations in the plastic structure;
a plurality of removable panels corresponding to the plurality of perforations;
wherein the plurality of removable panels are designed and configured for removal in locations corresponding to locations of the free-hand installed implants; and
wherein the plate is further configured to deliver the prosthesis on to the implants using the plastic plate.

13. The plate of claim 12, wherein the arch has a shape among one of a U-shaped arch, a square shaped arch, or a V-shaped arch in combination with a limited number of sizes.

14. The plate of claim 12, wherein the arch that mates with the plastic structure has the limited number of sizes of small/medium and large/extra-large.

15. The plate of claim 12, wherein the plate is further configured to enable the aligning of the set of removable panels with a surface of the prefabricated prosthesis.

16. The plate of claim 12, wherein the plate is further configured to use reline to set the prosthesis in place adjacent to the implant, enable removal of the plate from the reline and prosthesis once the reline is set, and enable the placement of the prosthesis back on the implants ready for immediate loading.

17. The plate of claim 12, wherein the plastic structure is made of translucent plastic.

18. The plate of claim 12, wherein the plastic structure is made of transparent plastic.

19. The plate of claim 12, wherein the plastic structure is made of a translucent or transparent plastic that can be cold sterilized or sterilized using ultra-violet light.

20. The plate of claim 12, wherein a removed panel on the removable panels on the plate enables the placement of an abutment onto the implant and further enables placement of marking ink or paint on the abutment to facilitate marking and creation of hole on the intaglio surface of the prefabricated prosthesis for alignment with the implants.
